(19) United States
(12) Patent Application Publication
(10) Pub. No.: US 2020/0234387 A1
(43) Pub. Date: Jul. 23, 2020

(54) ADMINISTERING CLAIMS INVOLVING LARGE MEMBER GROUPS UTILIZING SPECIFICALLY PROGRAMMED METHODS AND COMPUTER SYSTEMS

(71) Applicant: SourceHOV, Dallas, TX (US)

(72) Inventors: Eric Hudgens, Shakopee, MN (US); Nathan Schuck, Chaska, MN (US)

(21) Appl. No.: 16/843,168

(22) Filed: Apr. 8, 2020

Related U.S. Application Data
(63) Continuation of application No. 15/685,303, filed on Aug. 24, 2017.
Application No. 15/685,303 is a continuation of application No. 14/217,143, filed on Mar. 17, 2014, now abandoned.
(60) Provisional application No. 61/799,492, filed on Mar. 15, 2013.

(51) Int. Cl. G06Q 50/18; G06Q 10/10

(52) U.S. Cl. CPC G06Q 50/18; G06Q 10/10

(57) ABSTRACT

A method for claim processing is presented. The method includes receiving client data comprising potential claims, each potential claim initiated by multiple claimants. The method also includes identifying a first set of potential claims qualifying for a class based on eligibility criteria. The method further includes receiving an update to the eligibility criteria. The method still further includes identifying a second set of potential claims qualifying for the class based on the updated eligibility criteria. The method still further includes calculating a settlement distribution difference between the first set of potential claims and the second set of potential claims.

### CROSS-REFERENCE TO RELATED APPLICATIONS

This application is a continuation of U.S. patent application Ser. No. 15/685,303, filed on Aug. 24, 2017, which is a continuation of U.S. patent application Ser. No. 14/217,143, filed on Mar. 17, 2014 which claims priority to U.S. Provisional Application No. 61/799,492, filed on Mar. 15, 2013, the disclosures of which are incorporated by reference herein in their entireties.

### TECHNICAL FIELD

In some embodiments, the present invention relates to computer-implemented processing of claims in various industries.

### BACKGROUND

For purposes of the description of the instant invention, the terms “claim” or claims” refer to submission(s) (verbal and/or written) by, or on behalf of, a first entity (e.g., individual, company, organization, etc.) or a first group of entities to, directly or indirectly, a second entity or a second group of entities in which (i.e., in the submission(s)) the first entity or the first group of entities asserts an entitlement to be compensated, at least monetarily, by the second entity or the second group of entities.

### BRIEF SUMMARY OF INVENTION

In some embodiments, the instant invention provides a computer-implemented method that includes at least the following steps of: receiving, by a specifically programed claim processing computer system, first client claim data during a first time period, where the first client claim data comprises: i) incomplete information related to a plurality of potential claims involving at least 50 potential claimants, where the incomplete information lacks information required to distribute a compensation when a claimant submits a claim for adjudication, ii) a list of classes to classify the plurality of potential claims and the at least 50 potential claimant, or both, where each class of the list of classes is determined based at least in part on a plurality of classification rules, iii) a distribution fund information about a distribution fund, where the distribution fund is a value that is distributed on a pro-rata basis among qualified claims to compensate qualified claimants, and iv) a first plurality of eligibility criteria; identifying, by the specifically programed claim processing computer system, a first subset of potential claims involving at least 50 potential claimants from the first client claim data based on the first plurality of eligibility criteria; classifying, by the specifically programed claim processing computer system, the first subset of potential claims of the plurality of potential claims involving the at least 50 potential claimants into a first plurality of classes of the list of classes based at least in part on a statistical analysis of the first claim data information related to the plurality of potential claims involving at least 50 potential claimants; receiving, by the specifically programed claim processing computer system, at least one eligibility change to the first plurality of eligibility criteria during a second time period; determining, by the specifically programed claim processing computer system, a second plurality of eligibility criteria based on the at least one eligibility change to the first plurality of eligibility criteria; identifying, by the specifically programed claim processing computer system, a second subset of potential claims involving at least 50 potential claimants from the first client claim data based on: i) the second plurality of eligibility criteria and ii) historical data related to changes in one of: a) information of the potential claims involving at least 50 potential claimants, and b) subsets of potential claims involving at least 50 potential claimants; classifying, by the specifically programed claim processing computer system, the second subset of potential claims of the plurality of potential claims involving the at least 50 potential claimants into the plurality of classes of the list of classes based at least in part on the statistical analysis of the first claim data information related to the plurality of potential claims involving at least 50 potential claimants; for each class of the plurality of classes, automatically calculating, by the specifically programed claim processing computer system, at least one difference between the first subset of potential claims of the plurality of potential claims involving the at least 50 potential claimants and the second subset of potential claims of the plurality of potential claims involving the at least 50 potential claimants; and outputting, by the specifically programed claim processing computer system, the at least one difference before a third time period, where a time difference between the second time period and the third time period is less than 48 hours.

In some embodiments, the time difference between the second time period and the third time period is less than 24 hours. In some embodiments, the method further includes at least: receiving, by the specifically programed claim processing computer system, a plurality of claim submissions related to the plurality of potential claims involving the at least 50 potential claimants; automatically adjudicating, by the specifically programed claim processing computer system, the plurality of claim submissions to determine a plurality of eligible claims; automatically calculating, by the specifically programed claim processing computer system, the pro-rata distribution among the plurality of eligible claims based on: i) claim submission information from the claim submissions of the plurality of eligible claims, ii) the plurality of classes, and iii) the first client claim data.

In some embodiments, the method further includes at least: assigning, by the specifically programed claim processing computer system, a distribution priority among the plurality of eligible claims based on the plurality of classes.

In some embodiments, the method further includes at least: receiving, by the specifically programed claim processing computer system, a plurality of correspondence related to the plurality of claim submissions; automatically associating, by the specifically programed claim processing computer system, each correspondence of the plurality of correspondence with each respective claim submission of the plurality of claim submissions.

In some embodiments, the method further includes at least: automatically generating, by the specifically programed claim processing computer system, an audit trial for the associating each correspondence of the plurality of correspondence with each respective claim submission of the plurality of claim submissions. In some embodiments, the first client claim data comprises financial transaction data related to a lawsuit involving a securities class action, where at least a portion of the plurality of potential claims involving at least 50 potential claimants comprise a plurality of financial transactions per potential claim.

In some embodiments, the automatically adjudicating the plurality of claim submissions further includes at least: automatically determining, by the specifically programed claim processing computer system, at least one of the following: i) duplicate claims, and ii) duplicate transactions within a claim; automatically matching, by the specifically programed claim processing computer system, transactions; and automatically determining, by the specifically programed claim processing computer system, out-of-balance transactions.

In some embodiments, the automatically calculating the pro-rata distribution among the plurality of eligible claims further includes at least: i) calculating a loss based on at least one eligibility criterion, and ii) determining an award amount for each eligible claim in the pro-rata distribution among the plurality of eligible claims based on: 1) the loss determined for other eligible claims of the plurality of eligible claims, and 2) the distribution fund.

In some embodiments, the method further includes at least: dynamically instantiating, by the specifically programed claim processing computer system, for each user, an electronic profile of user privileges based on a plurality of user characteristics of such user. In some embodiments, the plurality of user characteristics comprise: i) at least one global characteristic that identifies such user's role related to an entity, and ii) at least one project-specific characteristic that identifies such user's role related to a project for which the first client claim data has been received.

In some embodiments, the instant invention provides a specifically programmed system that includes at least the following components: at least one programmed computer, having a non-transient computer tangible readable medium having stored thereon software instructions executable by at least one processor of the computer, where the software instructions at least include: code to receive first client claim data during a first time period, where the first client claim data comprises: i) incomplete information related to a plurality of potential claims involving at least 50 potential claimants, where the incomplete information lacks information required to distribute a compensation when a claimant submits a claim for adjudication, ii) a list of classes to classify the plurality of potential claims and the at least 50 potential claimant, or both, where each class of the list of classes is determined based at least in part on a plurality of classification rules, iii) a distribution fund information about a distribution fund, where the distribution fund is a value that is distributed on a pro-rata basis among qualified claims to compensate qualified claimants, and iv) a first plurality of eligibility criteria; code to identify a first subset of potential claims involving at least 50 potential claimants from the first client claim data based on the first plurality of eligibility criteria; code to classify the first subset of potential claims of the plurality of potential claims involving the at least 50 potential claimants into a first plurality of classes of the list of classes based at least in part on a statistical analysis of the first claim data information related to the plurality of potential claims involving at least 50 potential claimants; code to receive at least one eligibility change to the first plurality of eligibility criteria during a second time period; code to determine a second plurality of eligibility criteria based on the at least one eligibility change to the first plurality of eligibility criteria; code to identify a second subset of potential claims involving at least 50 potential claimants from the first client claim data based on: i) the second plurality of eligibility criteria and ii) historical data related to changes in one of: a) information of the potential claims involving at least 50 potential claimants, and b) subsets of potential claims involving at least 50 potential claimants; code to classify the second subset of potential claims of the plurality of potential claims involving the at least 50 potential claimants into the plurality of classes of the list of classes based at least in part on the statistical analysis of the first claim data information related to the plurality of potential claims involving at least 50 potential claimants; for each class of the plurality of classes, code to automatically calculate at least one difference between the first subset of potential claims of the plurality of potential claims involving the at least 50 potential claimants and the second subset of potential claims of the plurality of potential claims involving the at least 50 potential claimants; and code to output the at least one difference before a third time period, where a time difference between the second time period and the third time period is less than 48 hours.

### BRIEF DESCRIPTION OF THE DRAWINGS

The present invention will be further explained with reference to the attached figures. The figures constitute a part of this specification and include illustrative embodiments of the present invention and illustrate various objects and features thereof. Specific functional details disclosed herein are not to be interpreted as limiting, but merely as a representative basis for teaching one skilled in the art to variously employ the present invention.

FIG. 1 illustrates aspects of some embodiments of the instant invention.

FIG. 2 illustrates further aspects of some embodiments of the instant invention.

FIG. 3 illustrates yet further aspects of some embodiments of the instant invention.

FIGS. 4A-4C illustrate yet further aspects of some embodiments of the instant invention.

FIG. 5 illustrates yet further aspects of some embodiments of the instant invention.

FIG. 6 illustrates yet further aspects of some embodiments of the instant invention.

FIGS. 7A-7F illustrate yet further aspects of some embodiments of the instant invention.

FIG. 8 illustrates an exemplary computer system according to some embodiments of the invention.

FIGS. 9-11 illustrates further aspects of some embodiments of the instant invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Any alterations and further modifications of the inventive feature illustrated herein, and any additional applications of the principles of the invention as illustrated herein, which can normally occur to one skilled in the relevant art and having possession of this disclosure, are to be considered within the scope of the invention.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the present invention provides specifically programmed computer systems that administer claims, distribute funds, pay account payable and other similarly suitable processes in various industries. In some embodiments, the specifically programmed computer systems of the instant invention incorporate one or more rule-based engines that load, track, price, and audit claims. In some embodiments, the specifically programmed computer systems of the instant invention also utilize communication modules that electronically receive, generate, and/or transmit information about claims such as correspondence to claimants, instructions to pay, etc.

It is understood that at least one aspect/functionality of various embodiments described herein can be performed in real-time and/or dynamically. As used herein, the term “real-time” is directed to an event/action can occur instantaneously or almost instantaneously in time when another event/action has occurred.

As used herein, the term “dynamic(ly)” is directed to an event/action that can occur without any human intervention. In some embodiments, the dynamic event/action may be in real-time, hourly, daily, weekly, monthly, etc.

In some embodiments, the specifically programmed computer systems of the instant invention can utilize mathematical/statistical model(s) to classify submitted claims and/or claimants into a plurality of classes based on predetermined and/or ad hoc established one or more criteria. In some embodiments, the specifically programmed computer systems of the instant invention can utilize mathematical/statistical model(s) to classify potential claims (i.e., claims that could qualify for compensation if they are submitted) that and/or potential claimants (i.e., claimants that could qualify for compensation if they submit their claims) into a plurality of classes based on predetermined and/or ad hoc established one or more criteria. In some embodiments, the instant invention can utilize different stratifications of classes. For example, a lawnmower class action case where push-mowers are a subset of the overall class, and riding mowers would be a different subset entitled to a higher payment. Typically, such classification can be utilized in consumer cases where a formula's basis relies on a product purchased by the class member. For instance, even though all class members are deemed putative class members on the basis of a purchase, they will fall into different subsets based on which actual product they purchased.

In some embodiments, the mathematical/statistical model(s) rely on at least one of the following, but not limited to:

Analysis of variance (ANOVA),

Chi-squared test,

Correlation,

Factor analysis,

Mann-Whitney U,

Mean square weighted deviation (MSWD),

Pearson product-moment correlation coefficient,

Regression analysis,

Spearman's rank correlation coefficient,

Student's t-test, and

Time series analysis.

In some embodiments, the specifically programmed computer systems of the instant invention can utilize mathematical/statistical model(s) to automatically quantify changes in pools of compensation eligible claims based on ad hoc change(s) in parameter(s) of claims and/or characteristic(s) of claimants. In some embodiments, the specifically programmed computer systems of the instant invention are capable of automatically quantify changes in pools of compensation eligible claims even when information stored in database(s) about potentially eligible claims is incomplete. In some embodiments, the specifically programmed computer systems of the instant invention utilize historical information and/or log(s) of changes to: (1) the information stored in database(s) about potentially eligible claims and/or (2) pools of compensation eligible claims,—to automatically and/or continuously improve estimations of subsequent calculations (active learning feedback loop).

In some embodiments, the instant invention allows to: (1) receive and process initial data about a class of claimants and/or claims, (2) receive subsequent data with different inclusion criteria or modifies the inclusion criteria of the initial data, and (3) administer both initial and subsequent data the same way.

In some embodiments, the instant invention provides a functionality of associating mail and other types of communication activities to claim records to have automatic traceability and audit trail for all claims.

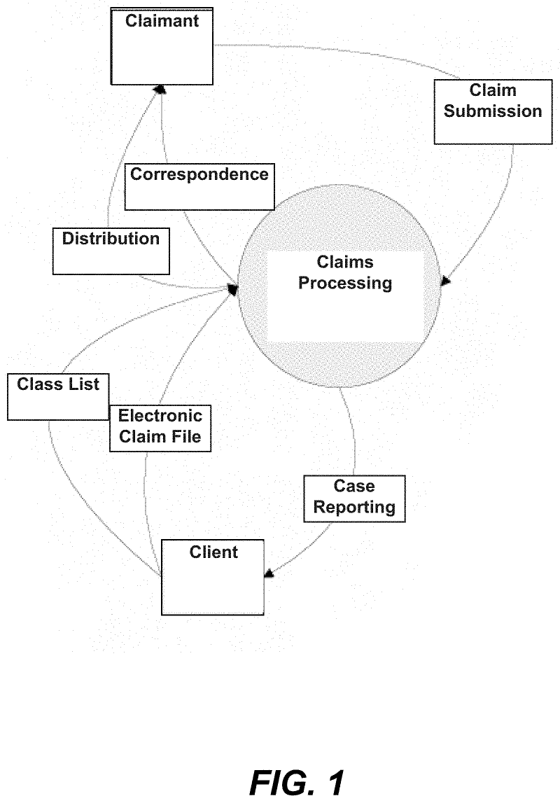

In accordance with some embodiments of the instant invention, FIG. 1 illustrates an exemplary process flowchart of the instant invention.

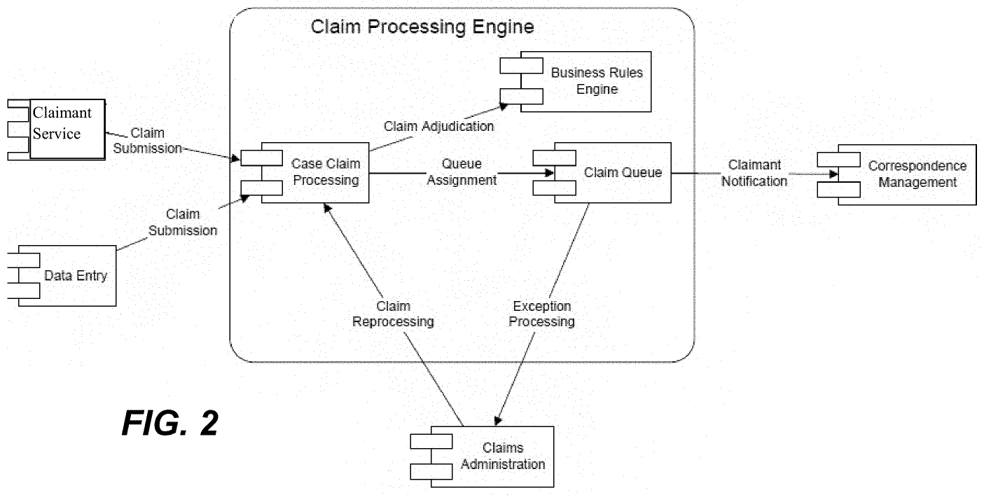

In accordance with some embodiments of the instant invention, FIG. 2 illustrates another exemplary process flowchart of the instant invention and some modules of an exemplary specifically programmed computer system of the instant invention.

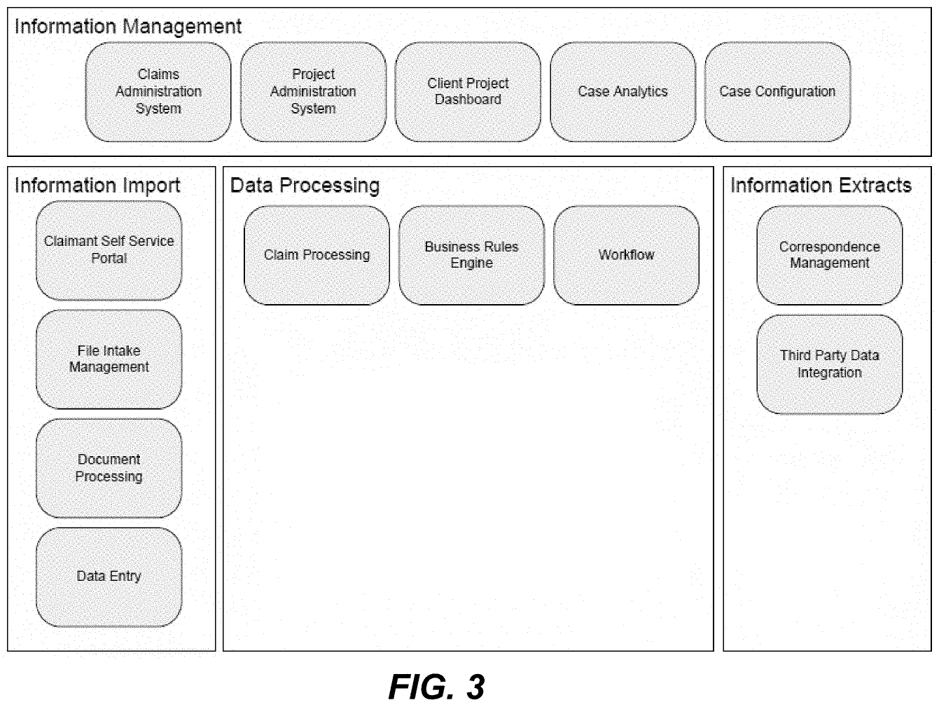

In accordance with some embodiments of the instant invention, FIG. 3 illustrates exemplary programmed modules and submodules of specifically programmed computer system of the instant invention.

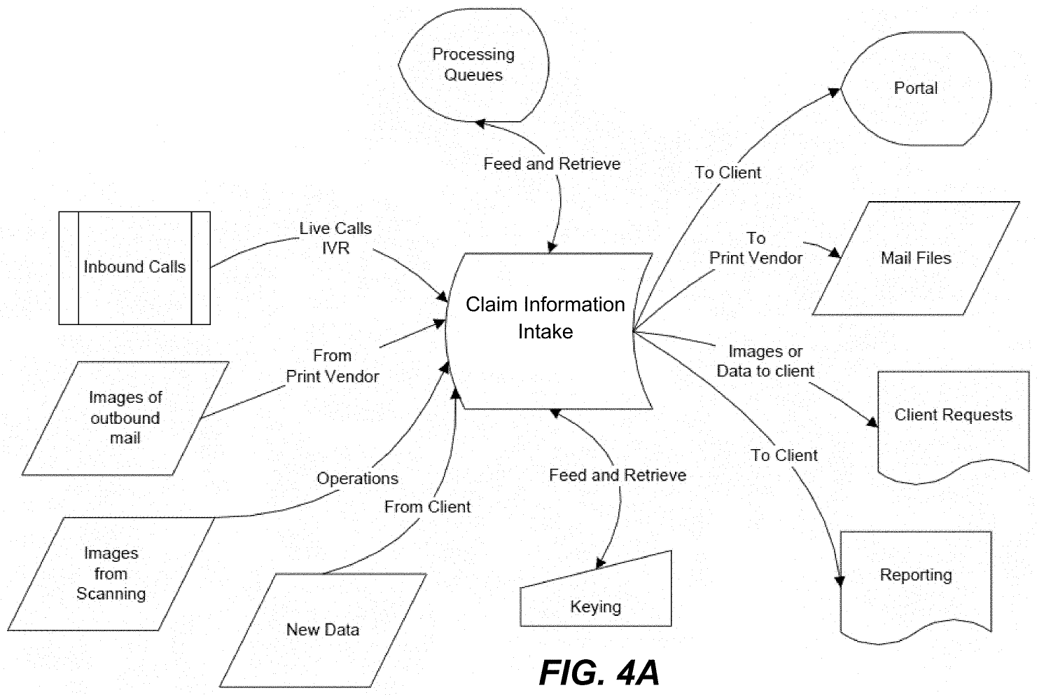

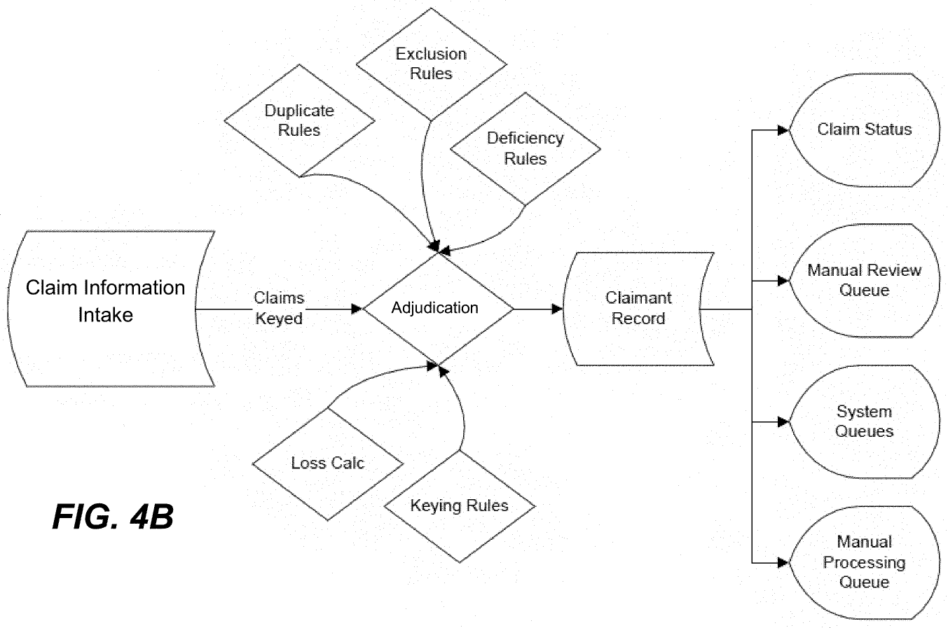

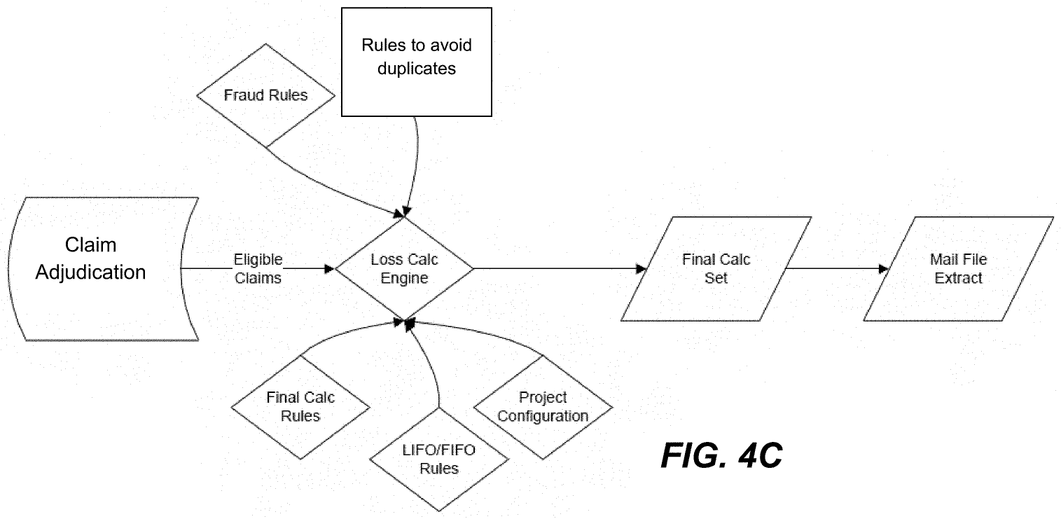

In accordance with some embodiments of the instant invention, FIGS. 4A-4C illustrate alternative exemplary methods of administering claims from an initial stage of claim information intake and data confirmation (FIG. 4A), through an adjudication process (FIG. 4B), and to a compensation distribution for eligible claims (FIG. 4C). The term “Client” is used in FIGS. 4A-4C to identify an entity that utilizes the specifically programmed computer systems of the instant invention to administer claims submitted by others. As shown in FIG. 4A, claim information can be scanned by utilizing, for example, scanning integration that uses smart barcodes (e.g., QR-code, etc) to self-identify document types and treatment of information for claim processing. 4. In accordance with some embodiments of the instant invention, the invention allows to establish relationships and/or create active linking between claims and information gathering activities. For instant, a record of a claim can include an active link to an audio recording of a call made regarding the claim.

As shown in FIG. 4C, the methods and specifically programmed computer systems of the instant invention claim can utilize compensation distribution directly integrated with bank(s)′ file reconciliation system(s). The term “calc” in FIGS. 4A-4C identifies various calculation performed with claim information. The term “LIFO/FIFO rules” in FIG. 4C identifies various rules establishing the priority of compensation payout among eligible claims (“LIFO” stands for a “last-in-first-out” priority order and “FIFO” stands for “first-in-first-out” priority order).

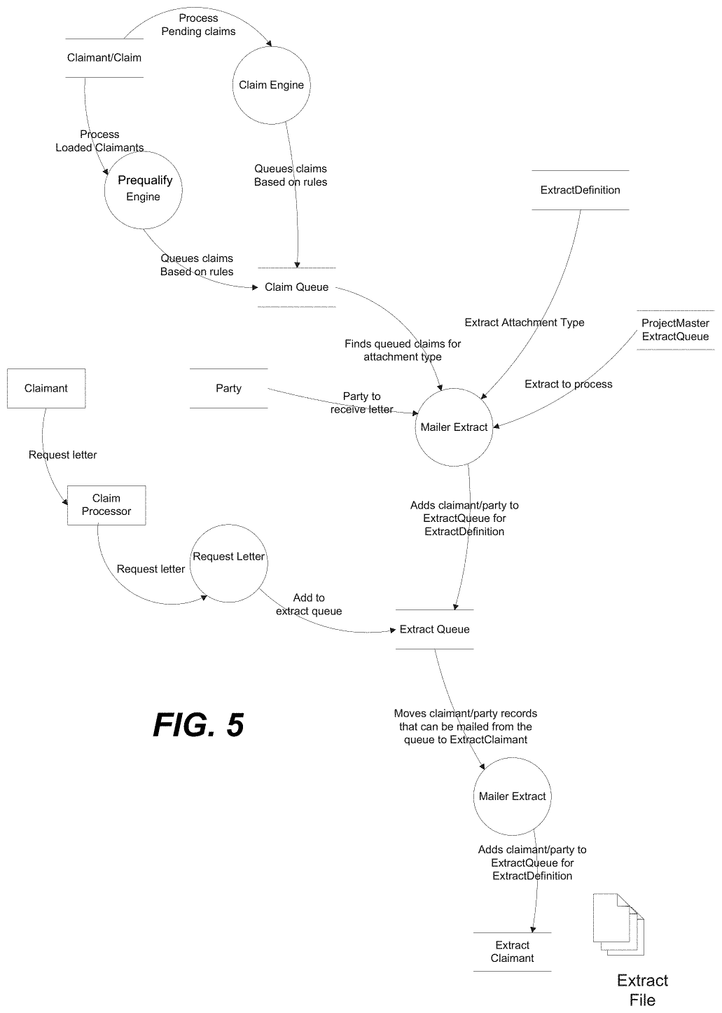

In accordance with some embodiments of the instant invention, FIG. 5 illustrates yet another exemplary process flowchart of the instant invention and some modules of yet another exemplary specifically programmed computer system of the instant invention.

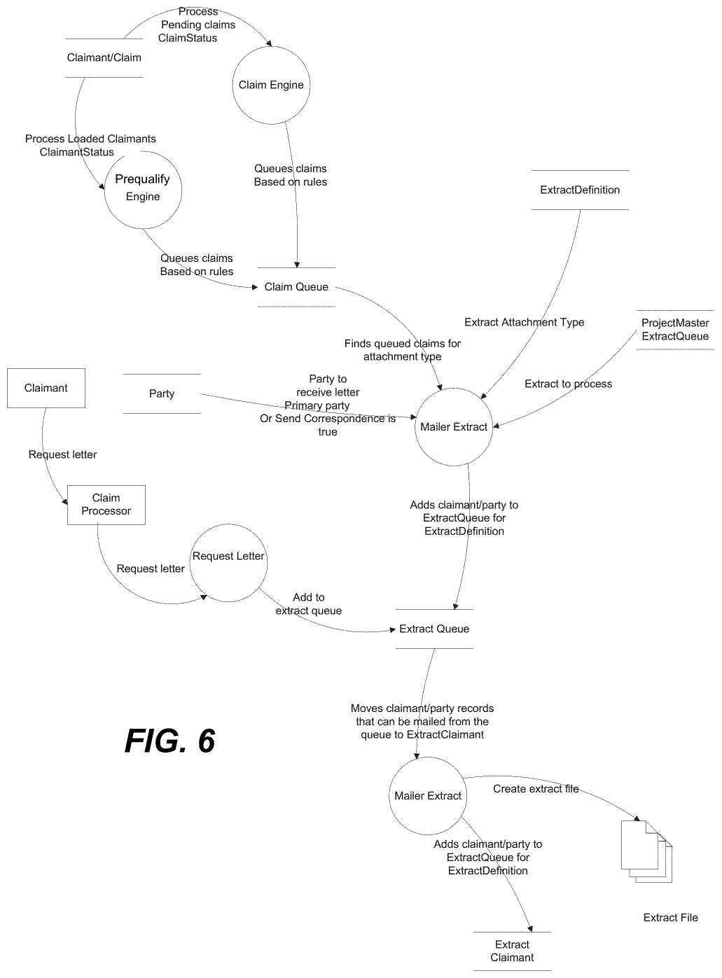

In accordance with some embodiments of the instant invention, FIG. 6 illustrates yet another exemplary method of the instant invention and some modules of another exemplary specifically programmed computer system of the instant invention.

FIGS. 5 and 6 illustrate methods of administering claims that are grouped into project(s) based one or more common criteria.

In some embodiments, specifically programmed computer systems of the instant invention can utilize pre-determined and/or ad hoc rules to identify potential claims and/or potential claimants from received information.

Illustrative Examples of Utilizing Some Embodiments of the Instant Invention in Legal Industry

For example, some embodiments of the instant invention are utilized to administer third-party claims in class action cases and mass tort settlements. In some cases, typically, a court would establish strict time deadlines that can include the following:

Preliminary Hearing,

Final Approval Hearing,

Effective Date,

Class Period,

Claim Period,

Objection Period,

Exclusion Period, and

Objection to Fees and Expenses.

In some embodiments, the methods and specifically programmed computer systems of the instant invention enables to administer claims within those strict time deadlines by managing client data (i.e., data about claims and/or claimants) throughout a standardized claim lifecycle. For example, the instant invention provides a functionality of associating claimant's responses with claim records to have automatic traceability and audit trail for all claims so that the accurate report(s) can be included in affidavits to court. In some embodiments, the instant invention allows clients of the specifically programmed computer systems of the instant invention and courts to track response rates including which mail was returned, forwarded, etc.

### Example 1: Class Action Securities/Securities & Exchange Commission (SEC) Actions

In some embodiments, as detailed herein, the present invention provides specifically programmed computer systems that administer claims, for example, in class action cases (e.g., class actions involving stock trading of a public company). Those cases typically involve large class member sizes defined as 50 claims and/or members/claimants and more and requires the methods and specifically programmed computer systems of the instant invention to collect/receive detailed transaction (buys/sells) data on all investment activity related to a particular settlement or class action case. In some embodiments, the methods and specifically programmed computer systems of the instant invention administer a large class of over 75 claims and/or members/claimants. In some embodiments, the methods and specifically programmed computer systems of the instant invention administer a large class of over 100 claims and/or members/claimants. In some embodiments, the methods and specifically programmed computer systems of the instant invention administer a large class of over 250 claims and/or members/claimants. In some embodiments, the methods and specifically programmed computer systems of the instant invention administer a large class of over 500 claims and/or members/claimants. In some embodiments, the methods and specifically programmed computer systems of the instant invention administer a large class of over 1000 claims and/or members/claimants.

In some embodiments, the methods and specifically programmed computer systems of the instant invention identify class qualification and/or award amount within strict time deadlines set by the court (e.g., 1-7 days turnaround) by performing at least the following:

1. identify duplicate claims;

2. identify duplicate transactions within a claim;

3. match transactions (typically, there are 5 or more transactions within a single claim) and determining out-of-balance transactions;

4. calculate a loss based on criteria of the settlement; and

5. determine award amount in a pro-rata that changes based on the results of other claims.

In some embodiments, the methods and specifically programmed computer systems of the instant invention administer claims when in addition to the baseline processes described above, the eligibility criteria for qualifying for an award could change with little notice from the court and maintaining the filing deadline of, for example, 2 days.

In some cases, there are 10 or more transactions within a single claim. In some cases, there are 20 or more transactions within a single claim. In some cases, there are 30 or more transactions within a single claim. In some cases, there are 50 or more transactions within a single claim. In some cases, there are 100 or more transactions within a single claim.

In some embodiments, the methods and specifically programmed computer systems of the instant invention administer claims when:

1) in some securities cases, a court may waive the requirement to provide documentation such as a statement of activity that shows proof of the stock sale at a certain price; and/or

2) in some other securities cases, the court may also decide to modify how they treat a type of transaction, such as a Merger transaction type as a buy which impacts the loss calculation.

In some embodiments, the methods and specifically programmed computer systems of the instant invention audits claim data to confirm the change was applied accurately and normalized. In some embodiments, the methods and specifically programmed computer systems of the instant invention administer claims by associating a particular transaction to a particular claim to a fund pool amount based at least in part on eligibility criteria applied to transactions.

In some embodiments, the methods and specifically programmed computer systems of the instant invention administer claims when the court and/or client require a change in the calculation criteria and still maintain the date for when to send checks and create the affidavit with confidence (i.e., the confident response that an operator of the methods and specifically programmed computer systems of the instant invention is confident that the operator can still meet the dates set by the court even if calculation have been changed—an ability to expediently refactor the calculation criteria and be able to do so within a known timeframe (e.g., a court mandated response deadline, etc.)). For instance, the court can modify the Plan of Allocation (which was set by the court several days/weeks before) as a result of the initial language for the calculation being too broad and allowing for misinterpretation, resulting in a statement of clarification that requires a re-run of all distribution calculations while maintaining the same date (e.g., within a couple of days from the court's due date).

For example, in one case, in regard to the calculation of Put Options that were sold (wrote) during the Class Period, the Plan of Allocation initially stated: “For put options, a Trading Loss exists if the Total Sales Proceeds received from the sale of the option is less than the Total Purchase Amount when the option was repurchased or exercised (or zero if not exercised).” In one case, if the intrinsic value (the difference between the Strike Price and the underlying stock's closing price on the day of exercise/assignment) is not utilized to determine the “Total Purchase Amount” when the put option is exercised/assigned, the Trading Gain associated with the put options offsets the total Recognized Claim, resulting in the claim ultimately calculating to No Loss. In another case, when the intrinsic value for the put options is utilized, a trading loss for the put options is produced as a Recognized Claim of certain dollar amount. consequently, in some embodiments, the methods and specifically programmed computer systems of the instant invention administer claims by allowing to conduct modeling and/or run reports of claims data based on ad hoc generated queries.

In some embodiments, the methods and specifically programmed computer systems of the instant invention administer claims by allowing to model a court's request to improve the take rate via changes in eligibility criteria as an input to the court review process and provide a confident response within 24 hours or less. In some embodiments, the methods and specifically programmed computer systems of the instant invention administer claims by allowing to model a court's request to improve the take rate via changes in eligibility criteria as an input to the court review process and provide a confident response within 48 hours or less. In some embodiments, the methods and specifically programmed computer systems of the instant invention administer claims by allowing to model a court's request to improve the take rate via changes in eligibility criteria as an input to the court review process and provide a confident response within 72 hours or less.

In some embodiments, administer claims by allowing to copy the production data and model out scenarios (what-if inquiries) within the strict time parameters required by litigations.

For example, an illustrative scenario is what would happen if the documentation requirement that proved the purchase of the product is removed for an anti-trust case, the methods and specifically programmed computer systems of the instant invention would identify how many additional class members would be included in the settlement fund. Typically, such cases involve thousands or tens of thousands of claims. To accomplish the determination under this scenario, in some embodiments, the methods and specifically programmed computer systems of the instant invention administer claims by capturing an explicit claim status and reason for the claim status. In some embodiments, the methods and specifically programmed computer systems of the instant invention then automatically modify the code on each eligible claim and extract those claims for calculation. In some embodiments, the methods and specifically programmed computer systems of the instant invention further provides a User Interface (UI) that is accessible by a client and allows clients to submit re-running scenarios.

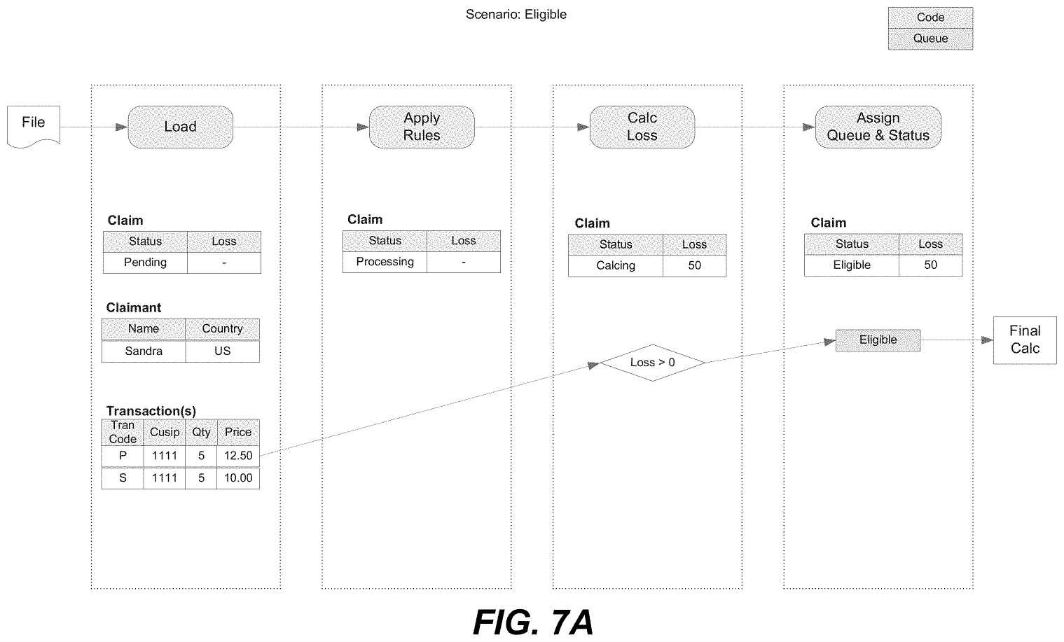

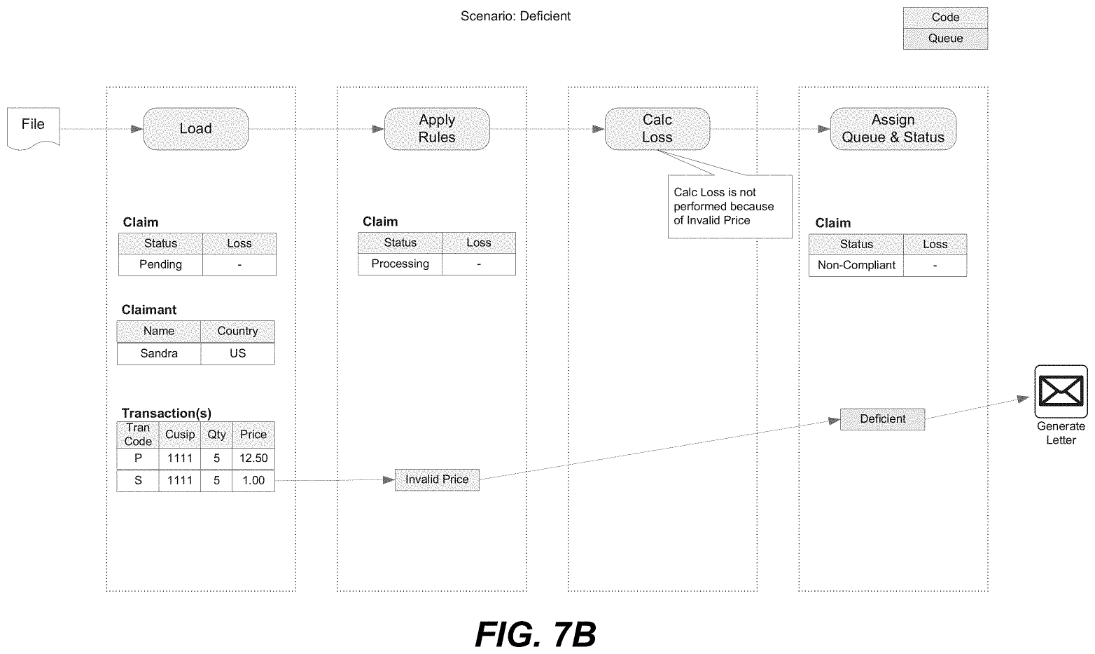

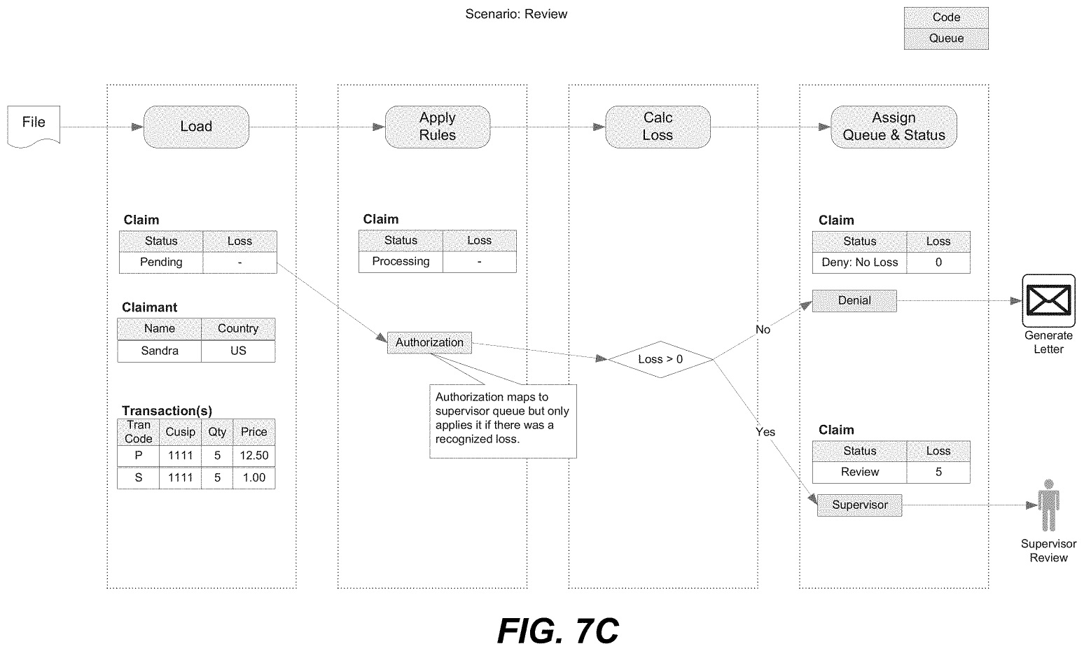

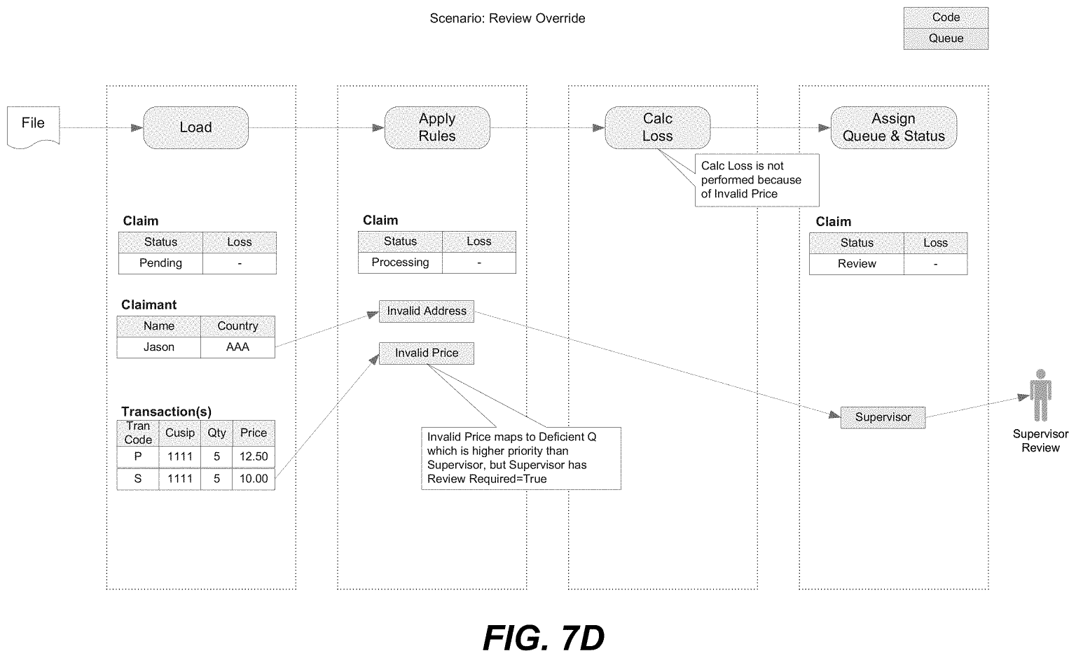

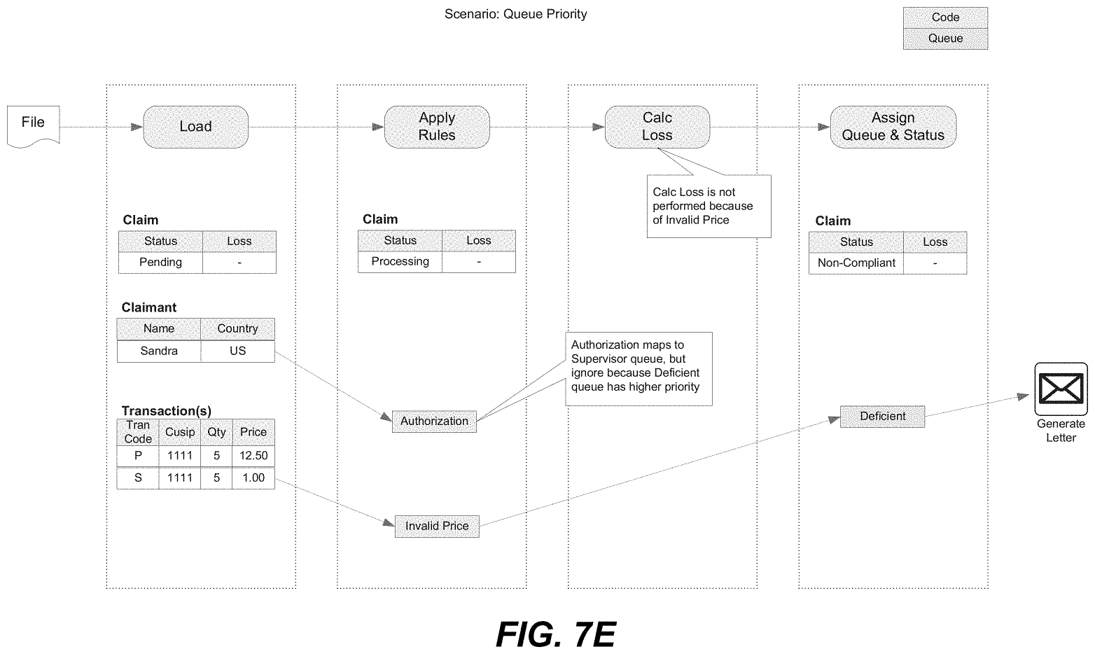

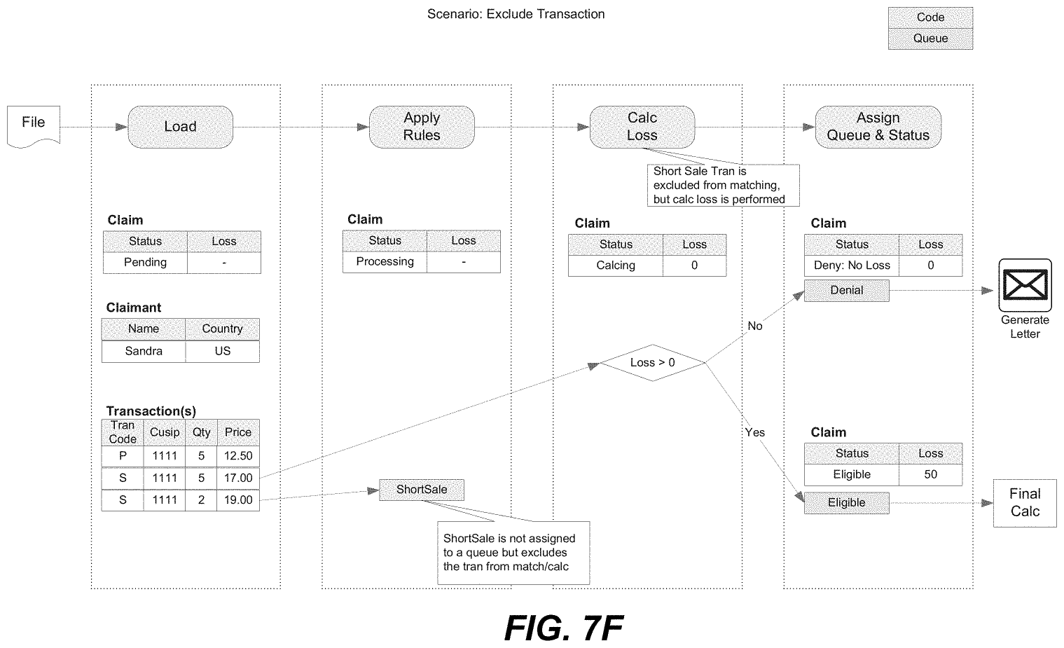

FIGS. 7A-7F illustrate exemplary administrating of claims for various scenarios in accordance with the methods and specifically programmed computer systems of the instant invention.

### Example 2: Class Action Consumer Cases

Typically, class action consumer cases involve thousands of claimants in which the award calculation is on pro rata basis. In some case, the initial projected pool can be 100,000 claimants and after a publication of the case, the initial pool could grow to a class action size of 500,000 and more claimants. Consequently, in class action consumer cases, the size of class is projected but typically is not known because unlike securities, it is difficult, if not impossible, to track who is impacted or who will respond. In some embodiments, the methods and specifically programmed computer systems of the instant invention administer claims of class action consumer cases by automatically adapting to a growing class size within the court deadlines that are still fixed regardless of class size.

Further, typically, consumer cases include award amounts in the form of coupons or services of the defendant's company. In some embodiments, the methods and specifically programmed computer systems of the instant invention administer claims of class action consumer cases by calculating the value for services or coupons to be awarded based on the client's proprietary data. An example of this could be a cellular company that provides the award as a credit of minutes on the individual's accounts. In some embodiments, the methods and specifically programmed computer systems of the instant invention administer claims of the cellular company by inputting the cellular company's proprietary information, performing a calculation of award and distributing a deliverable that identifies the award (i.e., minutes) for the cellular company to credit its customers.

### Example 3: Class Action Insurance/Healthcare Cases

In some embodiments, the methods and specifically programmed computer systems of the instant invention administer claims of insurance class actions by allowing for the adjudication to be reviewed in conjunction with internal proprietary insurance claim information and/or claimants' private information. In some embodiments, the methods and specifically programmed computer systems of the instant invention administer claims of insurance class actions by including/associating the class action claim form with the historical insurance claim form with data controls over who can see what information.

### Example 4: Property Cases

Typically, property cases involve multiple owners to one property over the course of a long class period of time. In some embodiments, the methods and specifically programmed computer systems of the instant invention administer claims of property actions by pro-rate calculating the award amount for each claimant/claim based on a timeframe across multiple owners for a time period in which they owned the property. In some cases that involves investment properties, typically, there are numerous owners involved at many times throughout the class period.

### Example 5: Mass Tort Settlement Administration

Typically, mass tort cases involve at least three sets of unique criteria that drive the complexity of the settlement. The first is that each state dictates a statute of limitations. The second is the date of use for the case, such as prescription for a RX settlement. The third is date of awareness of harm. In some embodiments, the methods and specifically programmed computer systems of the instant invention administer claims of mass tort cases by providing an ability to prove these dates in appropriate documentation along with responsible responsiveness by the attorney in settlement with system alerts and managing dates within the inventive systems. In some embodiments, the methods and specifically programmed computer systems of the instant invention administer claims of mass tort cases by maintaining with integrity the ability to view the data within a law firm across lawyers but protecting the data security at an individual case level.

### Example 6: Employment and Labor

Typically, employment cases have a class size of 500-1,000 members and require tracking numerous criteria and calculating multiple variables that include at least some of the following: hours worked, time codes, shifts, etc. In some embodiments, the class has 50 and more members. In some embodiments, the class has 100 and more members. In some embodiments, the class has 250 and more members. In some embodiments, the class has 1000 and more members.

In some embodiments, the methods and specifically programmed computer systems of the instant invention administer claims of employment actions by utilizing numerous criteria and variables recorded in case database(s) to automatically determine factor(s) that can be used to calculate an award. Further, in some embodiments, the methods and specifically programmed computer systems of the instant invention administer claims of employment actions by further calculating state and/or federal tax that need to be accounted for and paid. For example, it is typical for multiple states to be included in the calculation. In some embodiments, the methods and specifically programmed computer systems of the instant invention administer claims of employment actions by normalizing claim data that is received from numerous electronic sources which can have distinct format and data structures. Typically, the award calculations are done before there is an actual settlement and individual notices to class members are sent out with the Estimated Award Amount.

In some embodiments of the methods and specifically programmed computer systems of the instant invention, the following are some criteria that can be utilized, alone or in combination with each other, to calculate award:

Project delivery dates to perform service;
Change in requirements with fixed project delivery dates;
Volume of claims in relation to volume of underlying transactions;
Analytics on ‘what if’ scenario in very short timeframes with very high accuracy; and
Data security and separation of duties on data viewing within a settlement.

Illustrative Operating Environments of Some Embodiments of the Instant Invention

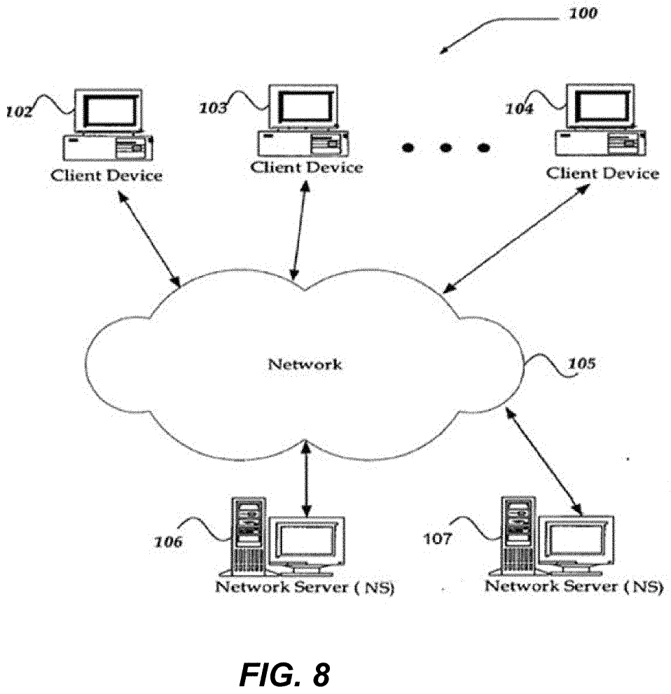

FIG. 8 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members (e.g., at least 500, at least 1,000, at least 10,000; at least 100,000; at least 1,000,000) and/or concurrent transactions (e.g., at least 500, at least 1,000; at least 10,000; at least 100,000; at least 1,000,000). In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the inventive computer system 102-104 (e.g., computer/mobile devices of clients of the specifically programmed computer systems of the instant invention: attorneys, companies, plaintiffs, defendants, etc.), include virtually any computing devices capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, the invention is programmed in either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

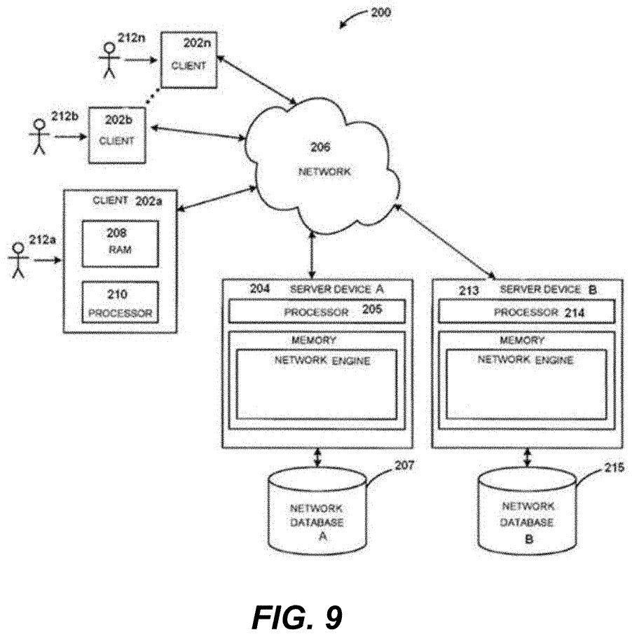

FIG. 9 shows another exemplary embodiment of the computer and network architecture that supports the inventive methods and systems. The member devices 202a, 202b thru 202n shown (e.g., computer/mobile devices of clients of the specifically programmed computer systems of the instant invention: attorneys, companies, plaintiffs, defendants, etc.), each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users (e.g., computer/mobile devices of clients of the specifically programmed computer systems of the instant invention: attorneys, companies, plaintiffs, defendants, etc.), 212a-n communicate over the network 206 with each other and with other systems and devices coupled to the network 206. As shown in FIG. 2, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

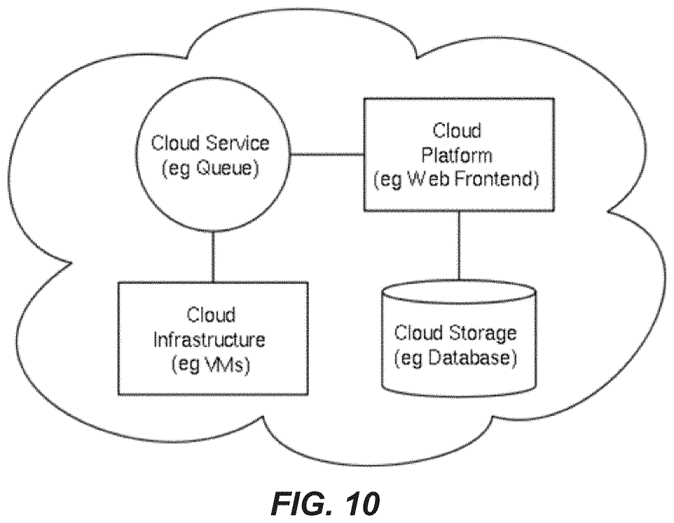

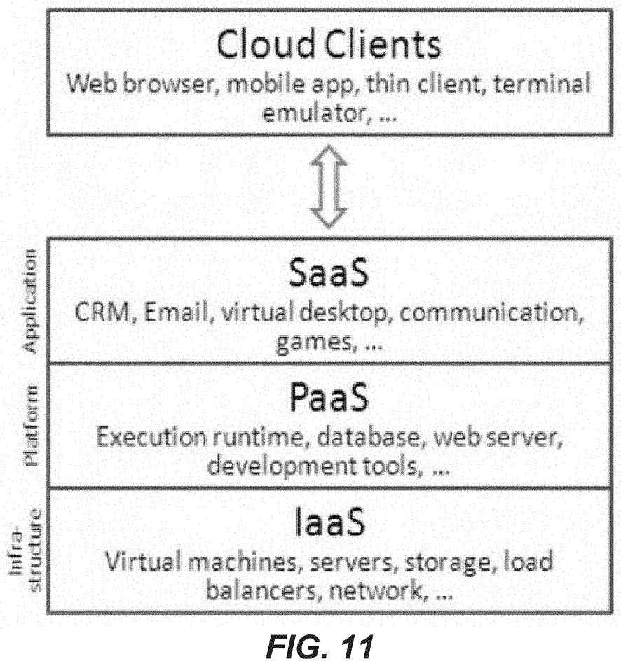

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 10 and 11 illustrate schematics of exemplary implementations of the cloud computing/architecture.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the instant invention includes a computer-implemented method that includes at least steps of: specifically programming a computer system to perform at least: receiving first financial transaction data from at least one first user, where the first financial transaction data includes information for a plurality of financial transactions that are subject to a plurality of potential claims from at least 50 claimants; automatically associating, based at least in part on first eligibility criteria, first subset of financial transactions from the plurality of financial transactions to: i) at least one first claim from the plurality of potential claims, where the at least one claim is associated with at least one first claimant, and ii) a fund pool amount; automatically validating the first subset of financial transactions to eliminate duplicate financial transactions; automatically matching the first subset of financial transactions to determine a second subset of out-of-balance financial transactions; calculating a first loss amount based, at least in part, on at least one first settlement criteria and second subset of out-of-balance financial transactions; determining a first award amount for the at least one first claim based, at least in part, on: i) the fund pool amount, ii) the plurality of potential claims, and iii) the first loss amount; and reporting the first award amount to the at least one first user.

In some embodiments, methods of the instant invention can further include at least: automatically validating the plurality of potential claims to eliminate duplicate claims.

In some embodiments, methods of the instant invention can further include at least: calculating a second loss amount based, at least in part, on at least one second settlement criteria and second subset of out-of-balance financial transactions, where the at least one second settlement criteria is distinct from the at least one first settlement criteria; and determining a second award amount for the at least one first claim based, at least in part, on: i) the fund pool amount, ii) the plurality of potential claims, and iii) the second loss amount, where the determining the second award amount is performed within 24 hours from a time when the specifically programmed computer system receives the at least one second settlement criteria.

In some embodiments, the first subset of transactions comprises at least ten transactions.

In some embodiments, the first subset of transactions comprises at least twenty transactions.

### Illustrative Examples of Security Management

In some embodiments, the inventive systems of the instant invention are specifically programmed to allow users (e.g., system managers, etc.) to define granular security permissions across different users (e.g., different based on roles, types (e.g., managers vs. subordinates, project members vs. non-members, etc.), etc.) to match their privileges with their roles and/or duties within the claim processing context. In some embodiments, the inventive security methodology utilized to specifically programmed the inventive systems (e.g., computer engine(s)) allows, for example, administrators to define role permissions at one or more global levels, which then can be refined at one or more project levels. In some embodiments, the inventive security methodology utilized to specifically programmed the inventive systems allows to dynamically instantiate a programmed instance (i.e., electronic profile) of user privileges based on who a user is in a general (e.g., global level) and/or specific (e.g., project level) context, and who the user is in relation to a specific project that s/he is handling/interacting with. For example, in some embodiments, the user can function as a project administrator on one project while acting as a processor on another project simultaneously without the need to edit hers/his global organizational role within the inventive system. In some embodiments, the specifically programmed the inventive systems use logical connection based data collected about user(s), project(s) (e.g., a securities class action case claim processing), and/or organization(s) (e.g., users' profiles, organizational structures, role assignments, tasks assignments, etc.) to that analyzes relationships between each user and one or more projects individually.

In some embodiments, the instant invention provides a computer-implemented method that includes at least the following steps of: receiving, by a specifically programed claim processing computer system, first client claim data during a first time period, where the first client claim data comprises: i) incomplete information related to a plurality of potential claims involving at least 50 potential claimants, where the incomplete information lacks information required to distribute a compensation when a claimant submits a claim for adjudication, ii) a list of classes to classify the plurality of potential claims and the at least 50 potential claimant, or both, where each class of the list of classes is determined based at least in part on a plurality of classification rules, iii) a distribution fund information about a distribution fund, where the distribution fund is a value that is distributed on a pro-rata basis among qualified claims to compensate qualified claimants, and iv) a first plurality of eligibility criteria; identifying, by the specifically programed claim processing computer system, a first subset of potential claims involving at least 50 potential claimants from the first client claim data based on the first plurality of eligibility criteria; classifying, by the specifically programed claim processing computer system, the first subset of potential claims of the plurality of potential claims involving the at least 50 potential claimants into a first plurality of classes of the list of classes based at least in part on a statistical analysis of the first claim data information related to the plurality of potential claims involving at least 50 potential claimants; receiving, by the specifically programed claim processing computer system, at least one eligibility change to the first plurality of eligibility criteria during a second time period; determining, by the specifically programed claim processing computer system, a second plurality of eligibility criteria based on the at least one eligibility change to the first plurality of eligibility criteria; identifying, by the specifically programed claim processing computer system, a second subset of potential claims involving at least 50 potential claimants from the first client claim data based on: i) the second plurality of eligibility criteria and ii) historical data related to changes in one of: a) information of the potential claims involving at least 50 potential claimants, and b) subsets of potential claims involving at least 50 potential claimants; classifying, by the specifically programed claim processing computer system, the second subset of potential claims of the plurality of potential claims involving the at least 50 potential claimants into the plurality of classes of the list of classes based at least in part on the statistical analysis of the first claim data information related to the plurality of potential claims involving at least 50 potential claimants; for each class of the plurality of classes, automatically calculating, by the specifically programed claim processing computer system, at least one difference between the first subset of potential claims of the plurality of potential claims involving the at least 50 potential claimants and the second subset of potential claims of the plurality of potential claims involving the at least 50 potential claimants; and outputting, by the specifically programed claim processing computer system, the at least one difference before a third time period, where a time difference between the second time period and the third time period is less than 48 hours.

In some embodiments, the time difference between the second time period and the third time period is less than 24 hours. In some embodiments, the method further includes at least: receiving, by the specifically programed claim processing computer system, a plurality of claim submissions related to the plurality of potential claims involving the at least 50 potential claimants; automatically adjudicating, by the specifically programed claim processing computer system, the plurality of claim submissions to determine a plurality of eligible claims; automatically calculating, by the specifically programed claim processing computer system, the pro-rata distribution among the plurality of eligible claims based on: i) claim submission information from the claim submissions of the plurality of eligible claims, ii) the plurality of classes, and iii) the first client claim data.

In some embodiments, the method further includes at least: assigning, by the specifically programed claim processing computer system, a distribution priority among the plurality of eligible claims based on the plurality of classes. In some embodiments, the method further includes at least: receiving, by the specifically programed claim processing computer system, a plurality of correspondence related to the plurality of claim submissions; automatically associating, by the specifically programed claim processing computer system, each correspondence of the plurality of correspondence with each respective claim submission of the plurality of claim submissions.

In some embodiments, the method further includes at least: automatically generating, by the specifically programed claim processing computer system, an audit trial for the associating each correspondence of the plurality of correspondence with each respective claim submission of the plurality of claim submissions. In some embodiments, the first client claim data comprises financial transaction data related to a lawsuit involving a securities class action, where at least a portion of the plurality of potential claims involving at least 50 potential claimants comprise a plurality of financial transactions per potential claim.

In some embodiments, the automatically adjudicating the plurality of claim submissions further includes at least: automatically determining, by the specifically programed claim processing computer system, at least one of the following: i) duplicate claims, and ii) duplicate transactions within a claim; automatically matching, by the specifically programed claim processing computer system, transactions; and automatically determining, by the specifically programed claim processing computer system, out-of-balance transactions.

In some embodiments, the automatically calculating the pro-rata distribution among the plurality of eligible claims further includes at least: i) calculating a loss based on at least one eligibility criterion, and ii) determining an award amount for each eligible claim in the pro-rata distribution among the plurality of eligible claims based on: 1) the loss determined for other eligible claims of the plurality of eligible claims, and 2) the distribution fund.

In some embodiments, the method further includes at least: dynamically instantiating, by the specifically programed claim processing computer system, for each user, an electronic profile of user privileges based on a plurality of user characteristics of such user. In some embodiments, the plurality of user characteristics comprise: i) at least one global characteristic that identifies such user's role related to an entity, and ii) at least one project-specific characteristic that identifies such user's role related to a project for which the first client claim data has been received.

In some embodiments, the instant invention provides a specifically programmed system that includes at least the following components: at least one programmed computer, having a non-transient computer tangible readable medium having stored thereon software instructions executable by at least one processor of the computer, where the software instructions at least include: code to receive first client claim data during a first time period, where the first client claim data comprises: i) incomplete information related to a plurality of potential claims involving at least 50 potential claimants, where the incomplete information lacks information required to distribute a compensation when a claimant submits a claim for adjudication, ii) a list of classes to classify the plurality of potential claims and the at least 50 potential claimant, or both, where each class of the list of classes is determined based at least in part on a plurality of classification rules, iii) a distribution fund information about a distribution fund, where the distribution fund is a value that is distributed on a pro-rata basis among qualified claims to compensate qualified claimants, and iv) a first plurality of eligibility criteria; code to identify a first subset of potential claims involving at least 50 potential claimants from the first client claim data based on the first plurality of eligibility criteria; code to classify the first subset of potential claims of the plurality of potential claims involving the at least 50 potential claimants into a first plurality of classes of the list of classes based at least in part on a statistical analysis of the first claim data information related to the plurality of potential claims involving at least 50 potential claimants; code to receive at least one eligibility change to the first plurality of eligibility criteria during a second time period; code to determine a second plurality of eligibility criteria based on the at least one eligibility change to the first plurality of eligibility criteria; code to identify a second subset of potential claims involving at least 50 potential claimants from the first client claim data based on: i) the second plurality of eligibility criteria and ii) historical data related to changes in one of: a) information of the potential claims involving at least 50 potential claimants, and b) subsets of potential claims involving at least 50 potential claimants; code to classify the second subset of potential claims of the plurality of potential claims involving the at least 50 potential claimants into the plurality of classes of the list of classes based at least in part on the statistical analysis of the first claim data information related to the plurality of potential claims involving at least 50 potential claimants; for each class of the plurality of classes, code to automatically calculate at least one difference between the first subset of potential claims of the plurality of potential claims involving the at least 50 potential claimants and the second subset of potential claims of the plurality of potential claims involving the at least 50 potential claimants; and code to output the at least one difference before a third time period, where a time difference between the second time period and the third time period is less than 48 hours.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method for claim processing by a claim processing computer system, comprising:
receiving client data comprising a plurality of potential claims, each potential claim initiated by a plurality of claimants;
identifying a first set of potential claims from the plurality of potential claims qualifying for a class based on eligibility criteria;
receiving an update to the eligibility criteria;
identifying a second set of potential claims from the plurality of potential claims qualifying for the class based on the updated eligibility criteria; and
calculating a settlement distribution difference between the first set of potential claims and the second set of potential claims.

2. The method of claim 1, wherein the plurality of potential claims lack information for distributing compensation when a claimant submits a claim for adjudication.

3. The method of claim 1, further comprising identifying the second set of potential claims based on historical data corresponding to the plurality of potential claims.

4. The method of claim 1, wherein a time difference between receiving the update and calculating the settlement distribution is less than a threshold.

5. The method of claim 1, further comprising:
receiving a plurality of claim submissions related to the plurality of potential claims;
adjudicating the plurality of claim submissions to determine a plurality of eligible claims; and
determining a pro-rata distribution among the plurality of eligible claims.

6. The method of claim 5, further comprising assigning a distribution priority among the plurality of eligible claims.

7. The method of claim 5, further comprising:
receiving a plurality of correspondence related to the plurality of claim submissions;
associating each of the plurality of correspondence with a claim submission of the plurality of claim submissions.

8. The method of claim 7, further comprising generating an audit trial for the associated correspondences.

9. The method of claim 1, further comprising:
identifying at least one of duplicate claims and duplicate transactions within a claim;
matching transactions; and
determining out-of-balance transactions.

10. An apparatus, comprising:
a memory; and
at least one processor coupled to the memory, the at least one processor configured:
to receive client data comprising a plurality of potential claims, each potential claim initiated by a plurality of claimants;
to identify a first set of potential claims from the plurality of potential claims qualifying for a class based on eligibility criteria;
to receive an update to the eligibility criteria;
to identify a second set of potential claims from the plurality of potential claims qualifying for the class based on the updated eligibility criteria; and
to calculate a settlement distribution difference between the first set of potential claims and the second set of potential claims.

11. The apparatus of claim 10, wherein the plurality of potential claims lack information for distributing compensation when a claimant submits a claim for adjudication.

12. The apparatus of claim 10, wherein the at least one processor is further configured to identify the second set of potential claims based on historical data corresponding to the plurality of potential claims.

13. The apparatus of claim 10, wherein a time difference between receiving the update and calculating the settlement distribution is less than a threshold.

14. The apparatus of claim 10, wherein the at least one processor is further configured:
to receive a plurality of claim submissions related to the plurality of potential claims;
to adjudicate the plurality of claim submissions to determine a plurality of eligible claims; and
to determine a pro-rata distribution among the plurality of eligible claims.

15. The apparatus of claim 14, wherein the at least one processor is further configured to assign a distribution priority among the plurality of eligible claims.

16. The apparatus of claim 14, wherein the at least one processor is further configured:
to receive a plurality of correspondence related to the plurality of claim submissions;
to associate each of the plurality of correspondence with a claim submission of the plurality of claim submissions.

17. The apparatus of claim 16, wherein the at least one processor is further configured to generate an audit trial for the associated correspondences.

18. The apparatus of claim 10, wherein the at least one processor is further configured:
to identify at least one of duplicate claims and duplicate transactions within a claim;
to match transactions; and
to determine out-of-balance transactions.

19. A non-transitory computer-readable medium having program code recorded thereon, the program code executed by a processor and comprising:
program code to receive client data comprising a plurality of potential claims, each potential claim initiated by a plurality of claimants;
program code to identify a first set of potential claims from the plurality of potential claims qualifying for a class based on eligibility criteria;
program code to receive an update to the eligibility criteria;
program code to identify a second set of potential claims from the plurality of potential claims qualifying for the class based on the updated eligibility criteria; and
program code to calculate a settlement distribution difference between the first set of potential claims and the second set of potential claims.
